(19) United States
(12) Patent Application Publication
(10) Pub. No.: US 2008/0088178 A1
(43) Pub. Date: Apr. 17, 2008

(54) Self-excitation system

(75) Inventor: Tai-Sheng Po, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/889,133

(22) Filed: Aug. 9, 2007

(30) Foreign Application Priority Data
Oct. 16, 2006 (TW) 095138044

(51) Int. Cl. H02J 3/00; H02J 1/00

(52) U.S. Cl. 307/17

(57) ABSTRACT

A self-excitation system includes a first transformer, a second transformer, a first self-excitation switching circuit and a second self-excitation switching circuit. The first transformer is electrically connected to the first self-excitation switching circuit and has a first resonance winding, a switching-control winding, a first synchronous switching-control winding and a first output winding. The first output winding is coupled to the first resonance winding, the switching-control winding and the first synchronous switching-control winding. The first synchronous switching-control winding is electrically connected to the second self-excitation switching circuit. The second transformer is electrically connected to the second self-excitation switching circuit. The second transformer has a second resonance winding, a second synchronous switching-control winding and a third output winding. The third output winding is coupled to the second resonance winding and the second synchronous switching-control winding.

### CROSS REFERENCE TO RELATED APPLICATIONS

This Non-provisional application claims priority under 35 U.S.C. §119(a) on Patent Application No(s). 095138044 filed in Taiwan, Republic of China on Oct. 16, 2006, the entire contents of which are hereby incorporated by reference.

### BACKGROUND OF THE INVENTION

1. Field of Invention

The invention relates to a resonance system and, in particular, to a self-excitation system.

2. Related Art

With the progress of the power electronic technology, power converters have become an indispensable assembly among the current products. The power converters are mainly classified into a direct current-direct current (DC-DC) power converter and an inverter. The inverter converts a DC power into an alternating (AC) power, and is widely applied to an electronic product such as a liquid crystal display (LCD) apparatus.

The LCD apparatus is mainly composed of a liquid crystal panel and a backlight module. In the current market, a cold cathode fluorescent lamp (CCFL) is mainly served as a light source of the backlight module. The CCFL is actually a complex transducer and is driven by the AC power to emit light. The AC power is usually provided by the inverter. During the process of converting the AC power into the light, the factors influencing the converting efficiency include a lamp current, temperature, a waveform of the AC power, a lamp size, a working frequency, a gas composition in the lamp and a distance from the lamp to the neighboring conductor.

In general, the inverters may be classified into two groups according to the architecture thereof. The first group of inverters has the two-stage architecture configured under the consideration of the low cost, and includes the Royer self-excitation resonance inverters that are mostly widely used. The second group of inverters includes bridge resonance inverters, which has the single-stage architecture and includes a half-bridge resonance inverter and a full-bridge resonance inverter.

The Royer self-excitation resonance inverter will be briefly described in the following. Referring to FIG. 1, a conventional self-excitation resonance inverter 1 includes a transformer 11, a capacitor 12, a first transistor 13 and a second transistor 14. A primary side of the transformer 11 has a resonance winding 111 and a control winding 112, and a secondary side of the transformer 11 has an output winding 113. The capacitor 12 is connected to the resonance winding 111 in parallel. The first transistor 13 and the second transistor 14 are electrically connected to two terminals of the capacitor 12, respectively. The control winding 112 controls on/off operations of the first transistor 13 and the second transistor 14. The working frequency of the self-excitation resonance inverter 1 is generated according to the resonance between the resonance winding 111 of the transformer 11 and the capacitor 12, and the self-excitation resonance inverter 1 outputs a frequency-based AC power AC1 from the output winding 113. The AC power AC1 can drive the load, such as the CCFL, in a post stage.

As mentioned hereinabove, the working frequency of the self-excitation resonance inverter 1 is generated according to the resonance between the capacitor 12 and the resonance winding 111 serving as an inductor. Therefore, the working frequency may be changed under the influence of the component parameter errors of the resonance winding 111 and the capacitor 12. More particularly, if there are more and more loads, multiple self-excitation resonance inverters have to be used to drive the loads. In this case, the component parameter errors may cause different working frequencies in the self-excitation resonance inverters. Thus, the loads, such as the CCFLs, in the post stage generate the non-uniform light rays. However, in order to uniform the parameters of the components, it is necessary to sieve the qualified components austerely during the manufacturing processes. Consequently, the manufacturing cost will be increased.

Therefore, it is an important subject to provide a self-excitation system having synchronous frequency outputs to keep the quality of the product and to reduce the cost.

### SUMMARY OF THE INVENTION

In view of the foregoing, the invention is to provide a self-excitation system having synchronous frequency outputs.

To achieve the above purpose, the invention discloses a self-excitation system including a first self-excitation switching circuit and a first transformer. The first self-excitation switching circuit includes at least a first capacitor and a first switch set. In addition, the first capacitor is electrically connected to the first switch set. The first transformer is electrically connected to the first self-excitation switching circuit and includes a first resonance winding, a switching-control winding, a first synchronous switching-control winding and at least one first output winding. The first output winding is coupled to the first resonance winding, the switching-control winding and the first synchronous switching-control winding, respectively. The first resonance winding is electrically connected to the first switch set. The switching-control winding is electrically connected to the first switch set.

As mentioned above, the self-excitation system of the invention utilizes the resonance between the first resonance winding of the first transformer and the first capacitor of the self-excitation switching circuit to generate the frequency, and the frequency is induced to the switching-control winding and the synchronous switching-control winding to respectively control on/off operations of the switch sets. Thus, the system can have the synchronous working frequency, and the situation of the asynchronous frequencies caused by the component parameter errors can be avoided.

### BRIEF DESCRIPTION OF THE DRAWINGS

The invention will become more fully understood from the detailed description given herein below illustration only, and thus is not limitative of the present invention, and wherein:

FIG. 1 is a circuit diagram showing a conventional Royer self-excitation resonance inverter;

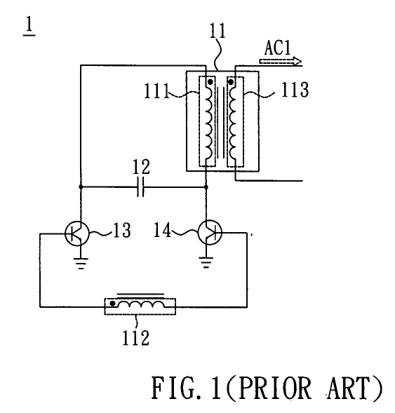

FIG. 2 is a schematic illustration showing a self-excitation system according to an embodiment of the invention;

FIG. 3 is a circuit diagram showing a detailed circuit of the self-excitation system in FIG. 2;

FIG. 4A is a schematic illustration showing a self-excitation system including a first load, a second load, a third load and a fourth load according to the embodiment of the invention; and

FIG. 4B is a schematic illustration showing a self-excitation system including a first output winding, a second output winding, a third output winding, a fourth output winding, a first load and a second load, a third load, and a fourth load according to the embodiment of the invention.

### DETAILED DESCRIPTION OF THE INVENTION

The present invention will be apparent from the following detailed description, which proceeds with reference to the accompanying drawings, wherein the same references relate to the same elements.

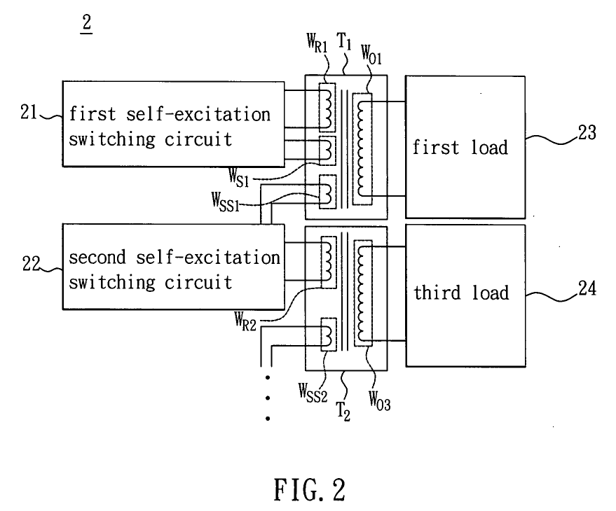

Referring to FIG. 2, a self-excitation system 2 according to an embodiment of the invention includes a first transformer T₁, a second transformer T₂, a first self-excitation switching circuit 21 and a second self-excitation switching circuit 22. In this embodiment, each of the first self-excitation switching circuit 21 and the second self-excitation switching circuit 22 is a Royer self-excitation switching circuit.

The first transformer T₁ is electrically connected to the first self-excitation switching circuit 21 and has a first resonance winding W_{R1}, a switching-control winding W_{S1}, a first synchronous switching-control winding W_{SS1} and a first output winding W_{O1}. The first output winding W_{O1} is coupled to the first resonance winding W_{R1}, the switching-control winding W_{S1} and the first synchronous switching-control winding W_{SS1}. The first synchronous switching-control winding W_{SS1} is electrically connected to the second self-excitation switching circuit 22, and the first output winding W_{O1} is electrically connected to a first load 23.

The second transformer T₂ is electrically connected to the second self-excitation switching circuit 22 and has a second resonance winding W_{R2}, a second synchronous switching-control winding W_{SS2} and a third output winding W_{O3}. The third output winding W_{O3} is coupled to the second resonance winding W_{R2} and the second synchronous switching-control winding W_{SS2}. The third output winding W_{O3} is electrically connected to a third load 24.

In this embodiment, each of the first load 23 and the third load 24 includes a CCFL or other loads that are driven by an AC power.

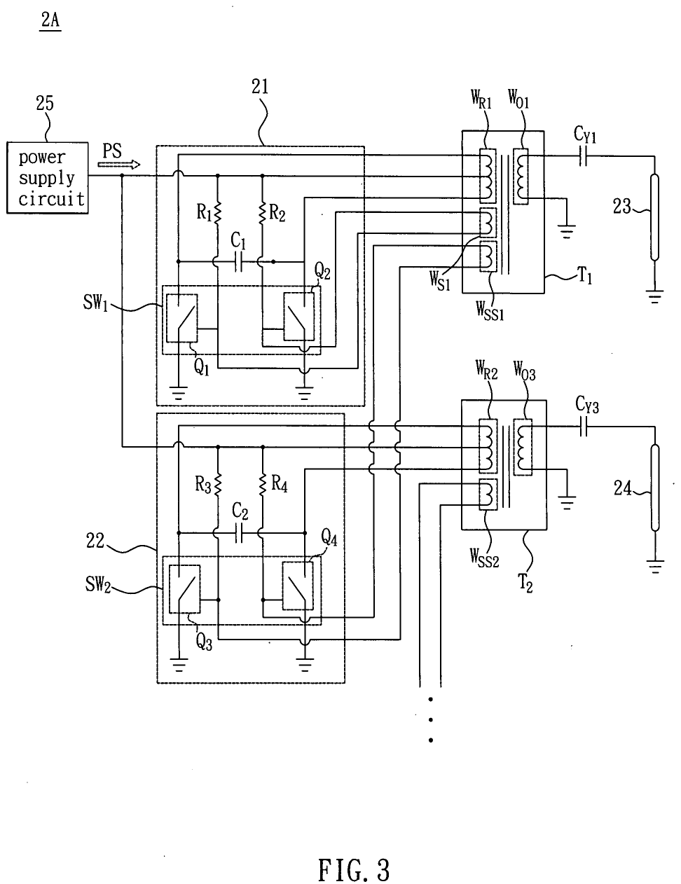

FIG. 3 is a circuit diagram showing detailed architecture of the self-excitation system 2 in FIG. 2.

Referring to FIG. 3, the first self-excitation switching circuit 21 includes a first capacitor C₁ and a first switch set SW₁. The first capacitor C₁ is electrically connected to the first switch set SW₁ and is electrically connected to the first resonance winding W_{R1} of the first transformer T₁ in parallel. In this embodiment, the first switch set SW₁ has a first switch element Q₁ and a second switch element Q₂, which are electrically connected to a first terminal and a second terminal of the first capacitor C₁, respectively. The first switch element Q₁ and a second switch element Q₂ are electrically connected to the switching-control winding W_{S1} of the first transformer T₁ to control on/off states of the first switch element Q₁ and the second switch element Q₂, respectively.

In addition, each of the first switch element Q₁ and the second switch element Q₂ includes, for example but not limited to, a bipolar transistor or a field effect transistor in this embodiment. If the first switch element Q₁ and the second switch element Q₂ are bipolar transistors, the switching-control winding W_{S1} of the first transformer T₁ is electrically connected to bases of the bipolar transistors to control on/off states of the bipolar transistors. If the first switch element Q₁ and the second switch element Q₂ are field effect transistors, the switching-control winding W_{S1} of the first transformer T₁ is electrically connected to gates of the field effect transistors to control on/off states of the field effect transistors.

The second self-excitation switching circuit 22 includes a second capacitor C₂ and a second switch set SW₂. The second capacitor C₂ is electrically connected to the second switch set SW₂, and is electrically connected to the second resonance winding W_{R2} of the second transformer T₂ in parallel. In this embodiment, the second switch set SW₂ has a third switch element Q₃ and a fourth switch element Q₄, which are electrically connected to a first terminal and a second terminal of the second capacitor C₂, respectively. The third switch element Q₃ and a fourth switch element Q₄ are electrically connected to the first synchronous switching-control winding W_{SS1} of the first transformer T₁ to control the third switch element Q₃ and the fourth switch element Q₄, respectively. The types and functions of the third switch element Q₃ and the fourth switch element Q₄ are the same as those of the first switch element Q₁ and the second switch element Q₂, so detailed descriptions thereof will be omitted. Because the frequency induced by the first synchronous switching-control winding W_{SS1} is the same as that induced by the switching-control winding W_{S1} it is possible to ensure the self-excitation system 2A to have the synchronous working frequency.

In addition, the self-excitation system 2A of this embodiment further includes a power supply circuit 25, which provides a power PS to the first resonance winding W_{R1} of the first transformer T₁ and the second resonance winding W_{R2} of the second transformer T₂. In addition, the power PS is a DC voltage in this embodiment.

Furthermore, the first self-excitation switching circuit 21 of this embodiment further includes a first resistor R₁ and a second resistor R₂, and the second self-excitation switching circuit 22 further includes a third resistor R₃ and a fourth resistor R₄. The first resistor R₁ and the second resistor R₂ are electrically connected to and between the power supply circuit 25 and the first switch set SW₁, and the third resistor R₃ and the fourth resistor R₄ are electrically connected to and between the power supply circuit 25 and the second switch set SW₂. It is to be noted that the first resistor R₁, the second resistor R₂, the third resistor R₃ and the fourth resistor R₄ are equivalent elements, and may be composed of a plurality of resistors depending on the actual requirement of the self-excitation switching circuit.

In detail, one terminal of the first resistor R₁ is electrically connected to the power supply circuit 25 and the first resonance winding W_{R1} of the first transformer T₁, and the other terminal of the first resistor R₁ is electrically connected to the first switch element Q₁ of the first switch set SW₁ and the switching-control winding W_{S1} of the first transformer T₁. One terminal of the second resistor R₂ is electrically connected to the power supply circuit 25 and the first resonance winding W_{R1} of the first transformer T₁, and the other terminal is electrically connected to the second switch element Q₂ of the first switch set SW₁ and the switching-control winding W_{S1} of the first transformer T₁. One terminal of the third resistor R₃ is electrically connected to the power supply circuit 25 and the second resonance winding W_{R2} of the second transformer T₂ and the other terminal of the third resistor R₃ is electrically connected to the third switch element Q₃ of the second switch set SW₂ and the first synchronous switching-control winding W_{SS1} of the first transformer T₁. One terminal of the fourth resistor R₄ is electrically connected to the power supply circuit 25 and the second resonance winding W_{R2} of the second transformer T₂, and the other terminal is electrically connected to the fourth switch element Q₄ of the second switch set SW₂ and the first synchronous switching-control winding W_{SS1} of the first transformer T₁.

In this embodiment, each of the first load 23 and the third load 24 is the CCFL, so a first regulating capacitor C_{Y1} can be connected to and between the first output winding W_{O1} of the first transformer T₁ and the first load 23 in series, and a third regulating capacitor C_{Y3} can be connected to and between the third output winding W_{O3} of the second transformer T₂ and the third load 24 in series. Thus, the DC component of the signals in the first output winding W_{O1} of the first transformer T₁ can be isolated and the signals for driving the loads can become more stable.

It is to be noted that the second synchronous switching-control winding W_{SS2} of the second transformer T₂ can be electrically connected to a third self-excitation switching circuit (not shown) in a next stage so that the working frequency thereof can be in synchronizing with the working frequency of the first self-excitation switching circuit 21 and the second self-excitation switching circuit 22.

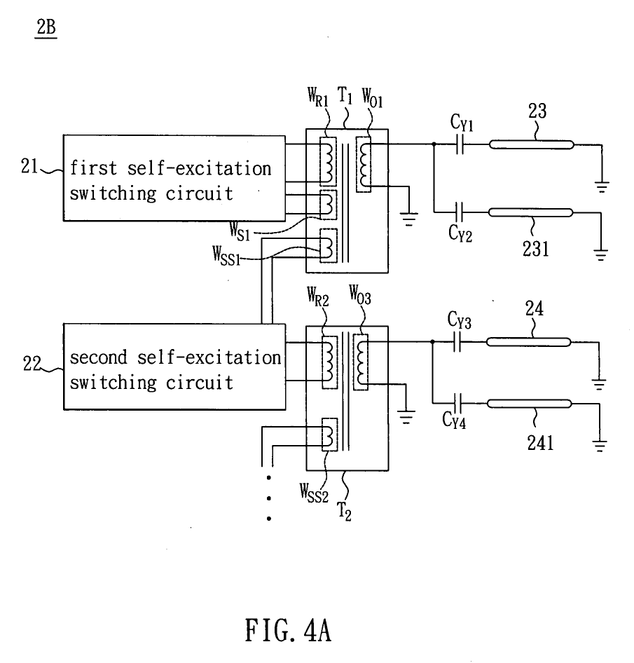

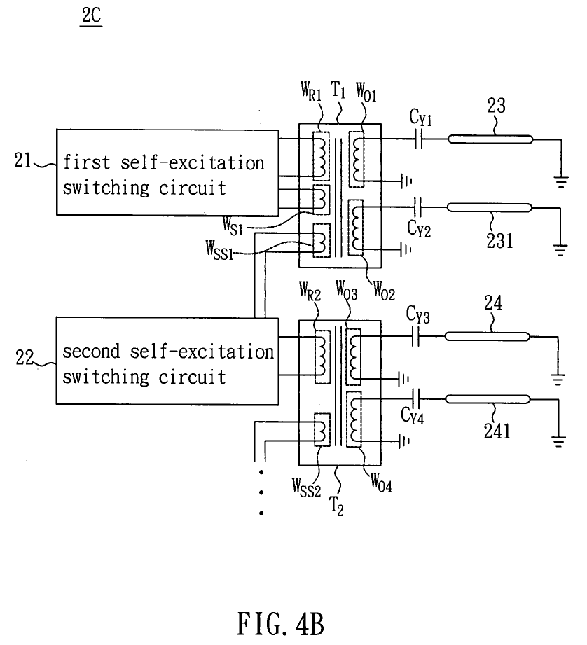

As shown in FIG. 4A, the self-excitation system 2B of this embodiment may further include a second load 231 and a fourth load 241. The second load 231 is electrically connected to the first output winding W_{O1} through a second regulating capacitor C_{Y2}, and the fourth load 241 is electrically connected to the third output winding W_{O3} through the fourth regulating capacitor C_{Y4}. In addition, in the self-excitation system 2C as shown in FIG. 4B, the first transformer T₁ may further include a second output winding W_{O2}, and the second transformer T₂ may further include a fourth output winding W_{O4}. The second regulating capacitor C_{Y2} and the second load 231 are electrically connected to the second output winding W_{O2}, and the fourth regulating capacitor C_{Y4} and the fourth load 241 are electrically connected to the fourth output winding W_{O4}.

In summary, the self-excitation system of the invention utilizes the resonance between the first resonance winding of the first transformer and the first capacitor of the self-excitation switching circuit to generate the frequency, and the frequency is induced to the switching-control winding and the synchronous switching-control winding to respectively control on/off operations of the switch sets. Thus, the system can have the synchronous working frequencies, and the situation of the asynchronous frequencies caused by the component parameter errors (component mismatch errors) can be avoided.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the scope of the invention.

What is claimed is:

1. A self-excitation system, comprising:
a first self-excitation switching circuit having a first switch set; and
a first transformer electrically connected to the first self-excitation switching circuit and having a first resonance winding, a switching-control winding, a first synchronous switching-control winding and at least one first output winding, wherein the first output winding is coupled to the first resonance winding, the switching-control winding and the first synchronous switching-control winding, respectively, the first resonance winding is electrically connected to the first switch set, and the switching-control winding is electrically connected to the first switch set.

2. The self-excitation system according to claim 1, wherein the first self-excitation switching circuit further comprises a first capacitor electrically connected to the first switch set and the first resonance winding.

3. The self-excitation system according to claim 2, wherein the first capacitor is electrically connected to the first resonance winding in parallel.

4. The self-excitation system according to claim 2, wherein the first switch set has at least two switch elements electrically connected to a first terminal and a second terminal of the first capacitor, respectively.

5. The self-excitation system according to claim 4, wherein the switching-control winding is electrically connected to the switch elements to control the switch elements.

6. The self-excitation system according to claim 4, wherein each of the switch elements is a bipolar transistor or a field effect transistor, and the switching-control winding is electrically connected to a base of the bipolar transistor or a gate of the field effect transistor.

7. The self-excitation system according to claim 1, further comprising a power supply circuit for providing a power or a direct current (DC) voltage to the first resonance winding.

8. The self-excitation system according to claim 7, wherein the first self-excitation switching circuit further comprises at least two resistors electrically connected between the power supply circuit and the first switch set.

9. The self-excitation system according to claim 1, wherein the first output winding of the first transformer is electrically connected to at least one first load, a cold cathode fluorescent lamp (CCFL) or a load driven by an alternating current (AC) power.

10. The self-excitation system according to claim 9, further comprising a first regulating capacitor connected to and between the first output winding and the first load in series.

11. The self-excitation system according to claim 10, further comprising a second load electrically connected to the first output winding through a second regulating capacitor.

12. The self-excitation system according to claim 9, wherein the first transformer further comprises a second output winding electrically connected to at least one second load, and the second load is connected to the second output winding through a second regulating capacitor.

13. The self-excitation system according to claim 1, wherein the first self-excitation switching circuit is a Royer self-excitation switching circuit.

14. The self-excitation system according to claim 1, further comprising:
a second self-excitation switching circuit having a second switch set electronically connected to the first synchronous switching-control winding of the first transformer; and
a second transformer electrically connected to the second self-excitation switching circuit and having a second resonance winding, a second synchronous switching-control winding and at least one third output winding, wherein the third output winding is coupled to the second resonance winding and the second synchronous switching-control winding, respectively, the second resonance winding is electrically connected to the second switch set.

15. The self-excitation system according to claim 14, wherein the second self-excitation switching circuit further comprises a second capacitor electrically connected to the second switch set and the second resonance winding.

16. The self-excitation system according to claim 15, wherein the second capacitor is connected to the second resonance winding in parallel.

17. The self-excitation system according to claim 15, wherein the second switch set has at least two switch elements electrically connected to a first terminal and a second terminal of the second capacitor, respectively.

18. The self-excitation system according to claim 17, wherein each of the switch elements is a bipolar transistor or a field effect transistor, and the second resonance winding is electrically connected to a base of the bipolar transistor or a gate of each of the field effect transistor.

19. The self-excitation system according to claim 14, further comprising a power supply circuit for providing a power or a direct current (DC) voltage to the first resonance winding and the second resonance winding.

20. The self-excitation system according to claim 19, further comprising at least two resistors electrically connected between the power supply circuit and the second switch set.

21. The self-excitation system according to claim 14, wherein the third output winding of the second transformer is electrically connected to at least one third load, a cold cathode fluorescent lamp (CCFL) or a load driven by an alternating current (AC) power.

22. The self-excitation system according to claim 21, wherein a third regulating capacitor is connected to and between the third output winding and the third load in series.

23. The self-excitation system according to claim 22, further comprising a fourth load electrically connected to the third output winding through a fourth regulating capacitor.

24. The self-excitation system according to claim 21, wherein the second transformer further comprises a fourth output winding electrically connected to at least one fourth load, and the fourth load is connected to the fourth output winding through a fourth regulating capacitor.
